(19) United States
(12) Patent Application Publication
(10) Pub. No.: US 2015/0185394 A1
(43) Pub. Date: Jul. 2, 2015

(54) LIGHT SOURCE MODULE AND DISPLAY DEVICE

(71) Applicant: E Ink Holdings Inc., Hsinchu (TW)

(72) Inventors: Hsin-Tao Huang, Hsinchu (TW); Shu-Li Hsiao, Hsinchu (TW)

(21) Appl. No.: 14/507,843

(22) Filed: Oct. 7, 2014

(30) Foreign Application Priority Data
Dec. 26, 2013 (TW) 102148493

(51) Int. Cl. F21V 8/00; G02F 1/1335

(52) U.S. Cl. CPC G02B 6/0028; G02F 1/133524; G02B 6/0008; G02B 6/0073

(57) ABSTRACT

A light source module that includes a light guide strip, at least one light-emitting device, and a light guide plate (LGP) is provided. The light guide strip includes at least one light-incident end and a light-emitting surface. The light-emitting surface is at least one portion of a side surface of the light guide strip, and the side surface is adjacent to the light-incident end. The light-emitting device is located beside the light-incident end and configured to emit light that enters the light-incident end. The LGP is located beside the light guide strip and has a first surface, a second surface, and a light-incident surface. The second surface is opposite to the first surface, and the light-incident surface is connected to the first surface and the second surface and faces the light-emitting device. The light guide strip surrounds the light-incident surface. A display device is also provided.

### CROSS-REFERENCE TO RELATED APPLICATION

This application claims the priority benefit of Taiwan application serial no. 102148493, filed on Dec. 26, 2013. The entirety of the above-mentioned patent application is hereby incorporated by reference herein and made a part of this specification.

### BACKGROUND OF THE INVENTION

1. Field of the Invention

The invention relates to a light source module and a display device.

2. Description of Related Art

With the continuous progress of display technologies, slim and customized display devices, such as liquid crystal display (LCD) devices or electrophoretic display devices, are the mainstream products on the market. The light, thin, and compact design of the display devices leads to the requirement for slimness and light weight of the light source modules (i.e., backlight modules and front light modules) in the display devices. In some existing electronic devices, e.g., mobile phones, tablet computers, or notebook computers, have been equipped with the rectangular light source modules characterized by compactness. These light source modules, when emitting a small amount of light, are still capable of properly providing the display devices with sufficient illumination if light guide plates (LGP) are together applied.

The requirements for the display devices in said and other electronic products are, however, not limited to the rectangular design. It is likely for the existing electronic products to have the display devices and the corresponding light source modules that are required to be shaped as circles, octagons, or in any other manner. Hence, the rectangular light source modules cannot be employed in the display devices. In a properly designed light source module, the design of the LGP and the location of the light source may need to be respectively modified and improved, thus resulting in the increasing manufacturing difficulties and costs. As a result, a light source module that may satisfy the requirement for various shapes is desired.

### SUMMARY OF THE INVENTION

The invention is directed to a light source module capable of providing a planar light source having uniform brightness, and the light source module is able to lessen the impact of the shape of the planar light source on the uniformity of brightness.

The invention is further directed to a display device capable of displaying high-quality images and lessening the impact of the image shape on the display quality of the images.

In an embodiment of the invention, a light source module that includes a light guide strip, at least one light-emitting device, and a light guide plate (LGP) is provided. The light guide strip includes at least one light-incident end and a light-emitting surface. The light-emitting surface is at least one portion of a side surface of the light guide strip, and the side surface is adjacent to the light-incident end. The light-emitting device is located beside the light-incident end and configured to emit light that enters the light-incident end. The LGP is located beside the light guide strip and has a first surface, a second surface, and a light-incident surface. The second surface is opposite to the first surface, and the light-incident surface is connected to the first surface and the second surface and faces the light-emitting device. The light guide strip surrounds the light-incident surface, and the light is adapted to enter the light guide strip from the light-incident end, adapted to be emitted from the light-emitting surface, adapted to enter the LGP from the light-incident surface, and then adapted to be emitted from at least one of the first surface and the second surface.

In an embodiment of the invention, a display device that includes a display panel and a light source module is provided. The light source module includes a light guide strip, at least one light-emitting device, and a light guide plate (LGP). The light guide strip includes at least one light-incident end and a light-emitting surface. The light-emitting surface is at least one portion of a side surface of the light guide strip, and the side surface is adjacent to the light-incident end. The light-emitting device is located beside the light-incident end and configured to emit light that enters the light-incident end. The LGP is located on one side of the display panel and beside the light guide strip. Besides, the LGP has a first surface, a second surface, and a light-incident surface. The second surface is opposite to the first surface, and the light-incident surface is connected to the first surface and the second surface and faces the light-emitting device. The light guide strip surrounds the light-incident surface, and the light is adapted to enter the light guide strip from the light-incident end, adapted to be emitted from the light-emitting surface, adapted to enter the LGP from the light-incident surface, and then adapted to be emitted from at least one of the first surface and the second surface and arrive at the display panel.

According to an embodiment of the invention, the light source module further includes at least one light coupling device connected to the light-emitting device and the light-incident end.

According to an embodiment of the invention, the number of the at least one light-emitting device is two, the number of the at least one light-incident end is two, the two light-incident ends are opposite to each other, and the two light-emitting devices are respectively located beside the two light-incident ends.

According to an embodiment of the invention, the light-emitting surface is one portion of the side surface of the light guide strip, the light guide strip further includes a reflection surface, the reflection surface is the other portion of the side surface of the light guide strip, and the light-emitting surface is located between the reflection surface and the light-incident surface.

According to an embodiment of the invention, the light guide strip further includes a reflection unit located on the reflection surface.

According to an embodiment of the invention, the LGP includes a plurality of first optical micro-structures located on the light-incident surface.

According to an embodiment of the invention, the LGP includes a plurality of second optical micro-structures located on at least one of the first surface and the second surface.

According to an embodiment of the invention, the light source module further includes a light guide medium that is located between the light-emitting surface and the light-incident surface.

According to an embodiment of the invention, the light guide strip is a side-emitting optical fiber.

According to an embodiment of the invention, the light-incident surface is a curved surface, and the light guide strip is bent along the curved surface.

According to an embodiment of the invention, the light-incident surface is sunken to accommodate at least one portion of the light guide strip.

In view of the above, the light guide strip in the light source module surrounds the light-incident surface of the LGP according to an embodiment of the invention; thereby, the light emitted from the light-emitting device may be converted into a linear light source surrounding the LGP, and each region of the LGP may be evenly illuminated. Hence, the light source module described herein is able to provide the uniform planar light source and lessen the impact of the shape of the planar light source on the uniformity of brightness. As a result, the display device described herein is capable of displaying high-quality images and lessening the impact of the image shape on the display quality of the images.

Several exemplary embodiments accompanied with figures are described in detail below to further describe the invention in details.

### BRIEF DESCRIPTION OF THE DRAWINGS

FIG. 1 is a schematic diagram illustrating a light source module according to a first embodiment of the invention.

FIG. 2 is a cross-sectional diagram illustrating the light source module depicted in FIG. 1 along a sectional line AA′.

FIG. 3A is a partial cross-sectional diagram illustrating a light source module according to an embodiment of the invention.

FIG. 3B is a partial cross-sectional diagram illustrating a light source module according to another embodiment of the invention.

FIG. 3C is a partial cross-sectional diagram illustrating a light source module according to a second embodiment of the invention.

FIGS. 3D and 3E are partial cross-sectional diagrams respectively illustrating light source modules according to other embodiments of the invention.

FIG. 4 is a schematic diagram illustrating a light source module according to the second embodiment of the invention.

FIG. 5 is a cross-sectional diagram illustrating a display device according to an embodiment of the invention.

FIG. 6 is a cross-sectional diagram illustrating a display device according to an embodiment of the invention.

### DETAILED DESCRIPTION OF DISCLOSED EMBODIMENTS

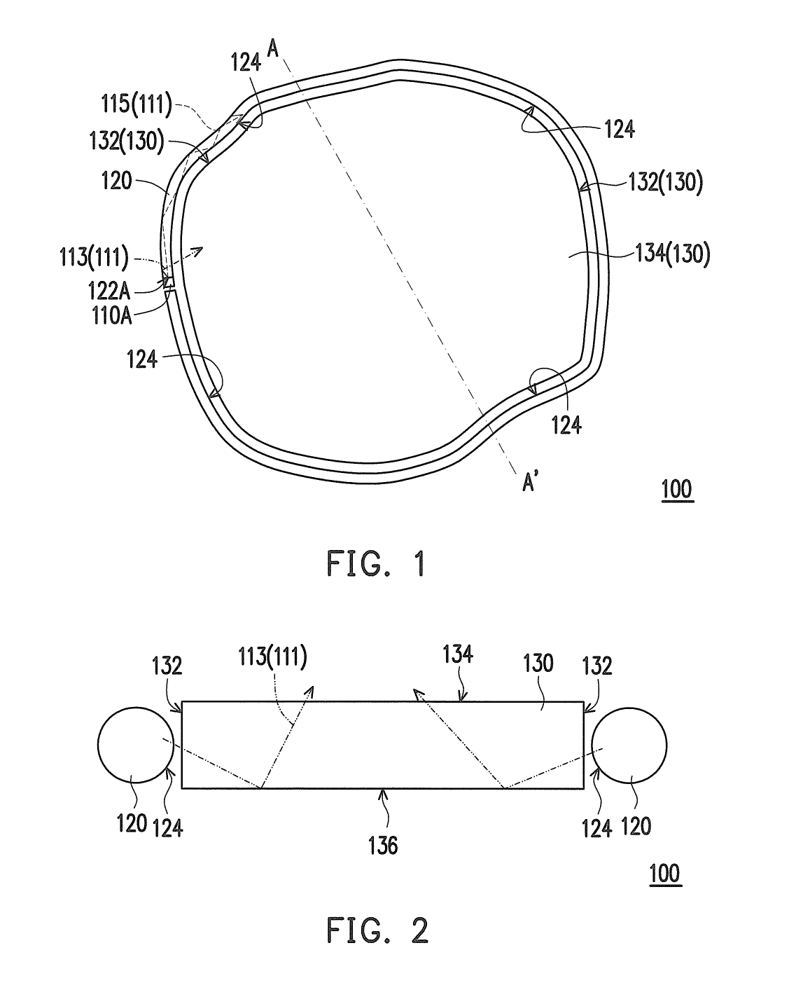

FIG. 1 is a schematic diagram illustrating a light source module according to a first embodiment of the invention. FIG. 2 is a cross-sectional diagram illustrating the light source module depicted in FIG. 1 along a sectional line AA′. With reference to FIG. 1, in the present embodiment, the light source module 100 includes a light-emitting device 110A, a light guide strip 120, and a light guide plate (LGP) 130, and the light guide strip 120 includes a light-incident end 122A and a light-emitting surface 124. According to the present embodiment, the light-emitting device 110A is adapted to emit light 111 that enters the light guide strip 120 from the light-incident end 122A. To be specific, the light guide strip 120 described herein is a side-emitting optical fiber, for instance; therefore, the light 111 may include light 113 and light 115. The light 115 is transmitted along the light guide strip 120, and the light 113 is emitted from the light-emitting surface 124 to the LGP 130. With reference to FIG. 1 and FIG. 2, in the present embodiment, the LGP 130 has a light-incident surface 132, a first surface 134, and a second surface 136 opposite to the first surface 134. Here, the light-incident surface 132 is adapted to receive the light 111 from the light-emitting surface 124; for instance, the light 113 is emitted from the light-emitting surface 124 and enters the light-incident surface 132. As shown in FIG. 2, in the present embodiment, after the light 113 enters the LGP 130, the light 113 is reflected by the second surface 136 and emitted from the first surface 134, for instance. In the present embodiment, the light guide strip 120 (i.e., the side-emitting optical fiber) is flexible and thus can easily surround the LGP 130 having the irregularly shaped first and second surfaces 134 and 136, as shown in FIG. 1. Accordingly, a small amount of light emitted from the light-emitting device 110A can still be converted into the linear light source that surrounds the LGP 130 and can then evenly illuminate each region of the LGP 130, so as to generate the uniform planar light source. In other embodiments of the invention, the shape of the first surface 134 and the second surface 136 of the LGP 130 may be a circle, an ellipse, a triangle, a rectangle, a square, an octagon, any other polygon, any other geometric shape, or any other irregular shape.

In the first embodiment of the invention, the light-emitting device 110A is a light-emitting diode (LED), which should however not be construed as a limitation to the invention; in other embodiments of the invention, the light-emitting device 110A may be an organic light-emitting diode (OLED) or another device adapted to emit light.

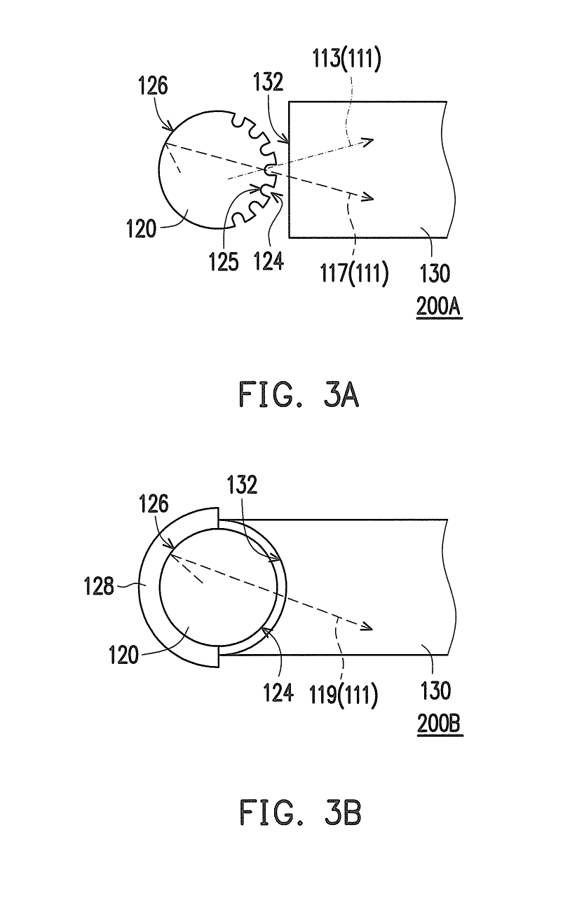

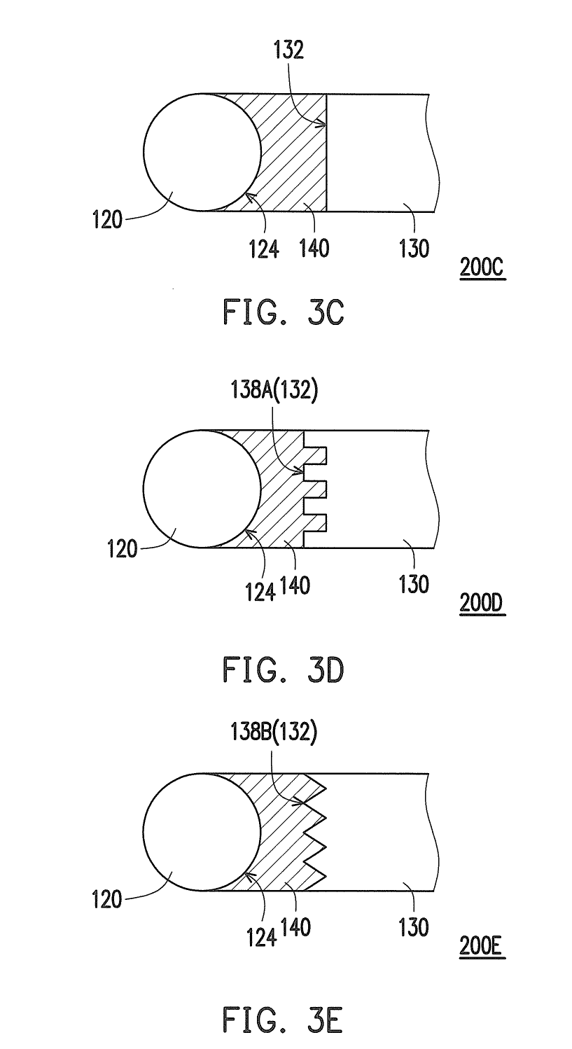

FIG. 3A is a partial cross-sectional diagram illustrating a light source module according to an embodiment of the invention. With reference to FIG. 3A, the light guide strip 120 of the light source module 200A described in the present embodiment further includes a reflection surface 126, and the light-emitting surface 124 is located between the reflection surface 126 and the light-incident surface 132. According to the present embodiment, the reflection surface 126 is adapted to reflect light toward a direction of the light-emitting surface 124, e.g., the light 117 hits the reflection surface 126, is reflected to the light-emitting surface 124, passes through the light-emitting surface 124, and the arrives at the light-incident surface 132, so as to accomplish favorable light-emitting efficiency. According to the present embodiment, the light guide strip 120 is formed by processing an optical fiber, for instance. Particularly, optical micro-structures 125 (i.e., micro-structures that are not smooth) are formed on the surface of the optical fiber through performing an etch process with use of acid, so as to form the light-emitting surface 124, while the invention is not limited thereto. In other embodiments of the invention, etch treatment or other appropriate treatment may be performed, such that the side surface of a portion of light guide strip 120 is adapted to emit light.

FIG. 3B is a partial cross-sectional diagram illustrating a light source module according to another embodiment of the invention. With reference to FIG. 3B, in the present embodiment, the light guide strip 120 further includes a reflection unit 128 that is located on the reflection surface 126 and adapted to reflect the light 111 passing through the reflection surface 126. To be specific, the reflection unit 128 provided in the present embodiment is adapted to reflect the light 119 from the reflection surface 126 back to the light guide strip 120, and the reflected light 119 then enters the LGP 130 to enhance the light-emitting efficiency. According to the present embodiment, the reflection unit 128 is a reflection film, for instance, which should however not be construed as a limitation to the invention. In other embodiments of the invention, the reflection unit 128 may be a reflection layer or a reflection shell, or the reflection unit 128 may be made of a material adapted for reflection and fixed to one side of the light guide strip 120.

With reference to FIG. 3B, the light-incident surface 132 described in the present embodiment is sunken to accommodate at least one portion of the light guide strip 120. Particularly, due to the design of the sunken light-incident surface 132, the surface area of the LGP 130 provided herein is expanded, and the light guide strip 120 is allowed to have the large light-emitting surface 124, so as to enhance the light-emitting efficiency. Moreover, the light guide strip 120 may be completely covered by the reflection unit 128 and the sunken light-incident surface 132, and thereby the light from the side surface of the light guide strip 120 is able to be fully utilized. In other embodiments of the invention, all side surfaces of the light guide strip 120 may all be the light-emitting surfaces if the design of the reflection unit 128 and the design of the sunken light-incident surface 132 may be properly modified.

FIG. 3C is a partial cross-sectional diagram illustrating a light source module according to a second embodiment of the invention. With reference to FIG. 3C, the light source module 200C provided in the present embodiment further includes a light guide medium 140 that is located between the light-emitting surface 124 and the light-incident surface 132. According to the present embodiment, the light guide medium 140 is a transparent medium that allows light emitted from the light-emitting device to pass through. In particular, the transparent medium provided herein may have the refractive index similar to those of the light guide strip 120 and the LGP 130, or the refractive index of the transparent medium may be between the refractive index of the light guide strip 120 and the refractive index of the LGP 130, such that the light may pass through the transparent medium 140 to a great extent, and the light-emitting efficiency of the light source module 200C may be improved.

FIGS. 3D and 3E are partial cross-sectional diagrams respectively illustrating light source modules according to other embodiments of the invention. With reference to FIG. 3D, the light source module 200D provided in the present embodiment is similar to the light source module 200C provided in the second embodiment, while the difference therebetween lies in that the LGP 130 in the light source module 200D has a plurality of first optical micro-structures 138A located on the light-incident surface 132, such that light may enter the light-incident surface 132 in an efficient manner. With reference to FIG. 3E, the light source module 200E provided in the present embodiment is similar to the light source module 200C provided in the second embodiment, while the difference therebetween lies in that the LGP 130 in the light source module 200E has a plurality of first optical micro-structures 138B located on the light-incident surface 132, such that light may enter the light-incident surface 132 in an efficient manner. Specifically, in the light source modules 200D and 200E provided in the embodiments of the invention, the amount of light reflected by the light-incident surface 132 may be reduced due to the design of the first optical micro-structures, and thereby the light is able to enter the light-incident surface 132 in an efficient manner. According to another embodiment of the invention, the first optical micro-structures may be formed on the light-incident surface through performing a carving process.

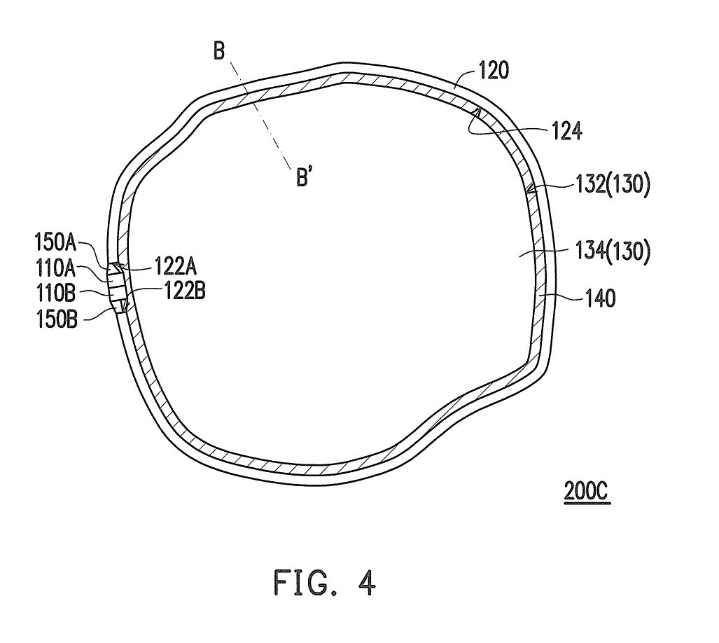

FIG. 4 is a schematic diagram illustrating a light source module according to the second embodiment of the invention, and FIG. 3C is, for instance, a cross-sectional diagram taken along a sectional line BB′ depicted in FIG. 4. With reference to FIG. 4, the light source module 200C described in the present embodiment has the light-emitting device 110A, the light-emitting device 110B, the light coupling device 150A, the light coupling device 150B, the light guide strip 120, the light guide medium 140, and the LGP 130. The light coupling device 150A is connected to the light-emitting device 110A and the light-incident end 122A, and the light coupling device 150B is connected to the light-emitting device 110B and the light-incident end 122B, such that the light from the light-emitting devices may enter the light-incident end in an efficient manner. In detail, the light coupling devices 150A and 150B are adapted to be respectively coupled to one light-emitting device and one light-incident end of one light guide strip, such that the light emitted from the light-emitting devices may enter the light guide strip in an efficient manner. According to the present embodiment, the light guide medium 140 is located between the light-emitting surface 124 and the light-incident surface 132 and is adapted to transmit light from the light-emitting surface 124 to the light-incident surface 132. The light guide strip 120 described herein is a non-flexible side-emitting light guide strip, for instance, which should however not be construed as a limitation to the invention. In other embodiments of the invention, the light guide strip of the light source module may be any other flexible or non-flexible light guide strip that surrounds the light-incident surface. The detailed structure of the light source module provided in the present embodiment is similar to that provided in the first embodiment and thus will not be further described hereinafter.

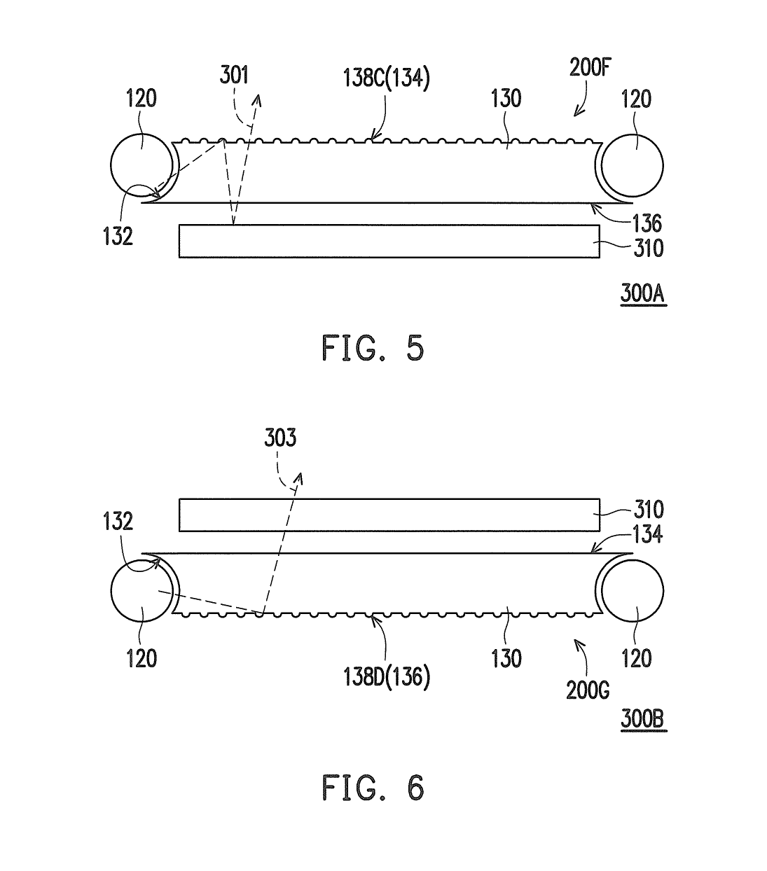

FIG. 5 is a cross-sectional diagram illustrating a display device according to an embodiment of the invention. With reference to FIG. 5, the display device 300A provided in the present embodiment includes a light source module 200F and a display panel 310, and the display panel 310 is a reflective display panel, for instance. The LGP 130 of the light source module 200F provided in the present embodiment has a plurality of second optical micro-structures 138C on the first surface 134, and the second optical micro-structures 138C are adapted to reflect the light from the light-incident surface 132 to the display panel 310 (i.e., the reflective display panel). In particular, after the light 301 enters the light-incident surface 132 from the light guide strip 120, the second optical micro-structures 138C reflect the light 301, and the reflected light 301 is emitted from the second surface 136 to the display panel 310 (i.e., the reflective display panel). That is, due to the second optical micro-structures 138C, the amount of light provided by the light source module 200F to the display panel 310 (i.e., the reflective display panel) is increased. According to the present embodiment, the display panel 310 is a reflective liquid crystal panel, which should however not be construed as a limitation to the invention. In other embodiments of the invention, the display panel 310 may be a reflective electrophoretic display panel or any other reflective display panel. To be specific, the display device provided in the present embodiment includes but is not limited to a display device of a watch. In another embodiment, the display device may also be employed in any other consumer electronics.

FIG. 6 is a cross-sectional diagram illustrating a display device according to another embodiment of the invention. In the present embodiment, the display device 300B provided in the present embodiment includes a light source module 200G and a display panel 310, and the display panel 310 is a transmission-type display panel, for instance. The LGP 130 of the light source module 200G provided in the present embodiment has a plurality of second optical micro-structures 138D on the second surface 136, and the second optical micro-structures 138D are adapted to reflect the light from the light-incident surface 132 to the display panel 310 (i.e., the transmission-type display panel). In particular, after the light 303 enters the light-incident surface 132 from the light guide strip 120, the second optical micro-structures 138D reflect the light 303, and the reflected light 303 is emitted from the first surface 134 to the display panel 310 (i.e., the transmission-type display panel). That is, due to the second optical micro-structures 138D, the amount of light provided by the light source module 200G to the display panel 310 (i.e., the transmission-type display panel) is increased.

With reference to FIG. 5 and FIG. 6, the light source module in the display device provided in the embodiments of the invention is neither limited to be the light source module 200F nor the light source module 200G; in other embodiments, the display device may further include the light source module 100 or any of the light source modules 200A to 200E, for instance. In an embodiment of the invention, the shape of the display panel may be the same as that of the LGP and may be irregular, for instance; however, the invention is not limited thereto. The display panel in other embodiments may have other shapes, and the shape of the LGP may be designed in a corresponding manner. In addition, since the light guide strip surrounds the light-incident surface of the LGP, the display panel may be provided with the favorable light source.

To sum up, the light guide strip in the light source module surrounds the light-incident surface of the LGP according to an embodiment of the invention; thereby, the light emitted from the light emitting device may be converted into a linear light source surrounding the LGP, and each region of the LGP may be evenly illuminated. Hence, the light source module described herein allows the design flexibility of the LGP to be enhanced; simultaneously, the light source is able to provide the uniform planar light source and lessen the impact of the shape of the planar light source on the uniformity of brightness. As a result, the display device equipped with the light source module is capable of displaying high-quality images and lessening the impact of the image shape on the display quality of the images without sacrificing the design flexibility.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A light source module comprising:
a light guide strip comprising:
at least one light-incident end; and
a light-emitting surface, the light-emitting surface being at least one portion of a side surface of the light guide strip, the side surface being adjacent to the at least one light-incident end;
at least one light-emitting device located beside the at least one light-incident end and configured to emit light entering the at least one light-incident end; and
a light guide plate located beside the light guide strip, the light guide plate having:
a first surface;
a second surface opposite to the first surface; and
a light-incident surface connected to the first surface and the second surface, the light-incident surface facing the light-emitting surface, wherein the light guide strip surrounds the light-incident surface, and the light is adapted to enter the light guide strip from the at least one light-incident end, adapted to be emitted from the light-emitting surface, adapted to enter the light guide plate from the light-incident surface, and then adapted to be emitted from at least one of the first surface and the second surface.

2. The light source module as recited in claim 1, further comprising at least one light coupling device connected to the at least one light-emitting device and the at least one light-incident end.

3. The light source module as recited in claim 1, wherein the number of the at least one light-emitting device is two, the number of the at least one light-incident end is two, the two light-incident ends are opposite to each other, and the two light-emitting devices are respectively located beside the two light-incident ends.

4. The light source module as recited in claim 1, wherein the light-emitting surface is one portion of the side surface of the light guide strip, the light guide strip further comprises a reflection surface, the reflection surface is the other portion of the side surface of the light guide strip, and the light-emitting surface is located between the reflection surface and the light-incident surface.

5. The light source module as recited in claim 4, wherein the light guide strip further comprises a reflection unit located on the reflection surface.

6. The light source module as recited in claim 1, wherein the light guide plate comprises a plurality of first optical micro-structures located on the light-incident surface.

7. The light source module as recited in claim 1, wherein the light guide plate comprises a plurality of second optical micro-structures located on at least one of the first surface and the second surface.

8. The light source module as recited in claim 1, further comprising:
a light guide medium located between the light-emitting surface and the light-incident surface.

9. The light source module as recited in claim 1, wherein the light guide strip is a side-emitting optical fiber.

10. The light source module as recited in claim 1, wherein the light-incident surface is a curved surface, and the light guide strip is bent along the curved surface.

11. The light source module as recited in claim 1, wherein the light-incident surface is sunken to accommodate at least one portion of the light guide strip.

12. A display device comprising:
a display panel; and
a light source module comprising:
a light guide strip comprising:
at least one light-incident end; and
a light-emitting surface, the light-emitting surface being at least one portion of a side surface of the light guide strip, the side surface being adjacent to the at least one light-incident end;
at least one light-emitting device located beside the at least one light-incident end and configured to emit light entering the at least one light-incident end; and
a light guide plate located on one side of the display panel and beside the light guide strip, the light guide plate having:
a first surface;
a second surface opposite to the first surface; and
a light-incident surface connected to the first surface and the second surface, the light-incident surface facing the light-emitting surface, wherein the light guide strip surrounds the light-incident surface, and the light is adapted to enter the light guide strip from the at least one light-incident end, adapted to be emitted from the light-emitting surface, adapted to enter the light guide plate from the light-incident surface, and then adapted to be emitted from at least one of the first surface and the second surface and arrive at the display panel.

13. The display device as recited in claim 12, wherein the at least one light-emitting device further comprises a light coupling device connected to the at least one light-emitting device and the at least one light-incident end.

14. The display device as recited in claim 12, wherein the number of the at least one light-emitting device is two, the number of the at least one light-incident end is two, the two light-incident ends are opposite to each other, and the two light-emitting devices are respectively located beside the two light-incident ends.

15. The display device as recited in claim 12, wherein the light-emitting surface is one portion of the side surface of the light guide strip, the light guide strip further comprises a reflection surface, the reflecting surface is the other portion of the side surface of the light guide strip, and the light-emitting surface is located between the reflection surface and the light-incident surface.

16. The display device as recited in claim 15, wherein the light guide strip further comprises a reflection unit located on the reflection surface.

17. The display device as recited in claim 12, wherein the light guide plate comprises a plurality of first optical micro-structures located on the light-incident surface.

18. The display device as recited in claim 12, wherein the light guide plate comprises a plurality of second optical micro-structures located on at least one of the first surface and the second surface.

19. The display device as recited in claim 12, wherein the light source module further comprises:
a light guide medium located between the light-emitting surface and the light-incident surface, wherein a refractive index of the light guide medium is greater than 1 and is smaller than a refractive index of the display panel.

20. The display device as recited in claim 12, wherein the light guide strip is a side-emitting optical fiber.

21. The display device as recited in claim 12, wherein the light-incident surface is a curved surface, and the light guide strip is bent along the curved surface.

22. The display device as recited in claim 12, wherein the light-incident surface is sunken to accommodate at least one portion of the light guide strip.
